(19) United States
(12) Patent Application Publication
(10) Pub. No.: US 2012/0161987 A1
(43) Pub. Date: Jun. 28, 2012

(54) APPARATUS AND METHOD FOR DETECTING VEHICLES

(75) Inventors: Jae-Jun YOO, Daejeon (KR); Do-Hyun KIM, Daejeon (KR)

(73) Assignee: Electronics and Telecommunications Research Institute, Daejeon-city (KR)

(21) Appl. No.: 13/333,397

(22) Filed: Dec. 21, 2011

(30) Foreign Application Priority Data
Dec. 23, 2010 (KR) 10-2010-0133951

(51) Int. Cl. G08G 1/01

(52) U.S. Cl. 340/933

(57) ABSTRACT

Disclosed herein are a method and apparatus for detecting vehicles. The apparatus include a signal generation unit and a vehicle detection unit. The signal generation unit generates a magnetic signal indicating a magnetic field versus time using a magnetic sensor. The vehicle detection unit generates magnetic signal waveform information, including a level value of the magnetic field of the magnetic signal per unit time, using a predetermined time summary unit and a magnetic signal summary unit, and extracts vehicle detection information, indicating whether a vehicle is present, from the magnetic signal waveform information.

### CROSS REFERENCE TO RELATED APPLICATION

This application claims the benefit of Korean Patent Application No. 10-2010-0133951, filed on Dec. 23, 2010, which is hereby incorporated by reference in its entirety into this application.

### BACKGROUND OF THE INVENTION

1. Technical Field

The present invention relates generally to an apparatus and method for detecting vehicles and, more particularly, to an apparatus and method for detecting vehicles using a magnetic sensor.

2. Description of the Related Art

Conventionally, in order to detect whether a vehicle is present in a road environment, a loop detector using current on a conductive line which varies when the vehicle moves, an image detector for analyzing a vehicle presence image, an ultrasonic sensor and a laser sensor using sound waves and a laser reflected from the vehicle, a magnetic sensor for detecting a magnetic field which varies when the vehicle moves, and so on have been utilized.

In particular, a magnetic sensor acquires a magnetic signal by detecting a change in the magnetic field which is generated when a vehicle moves, and determines whether a vehicle is present by processing the acquired magnetic signal.

A system for detecting vehicles based on a wireless sensor network using the magnetic sensor as described above is configured such that a wireless sensor network including magnetic sensor nodes including magnetic sensors is installed in a road environment and information about whether a vehicle is present, the speed of the vehicle, etc. are detected.

In the system for detecting vehicles, it is necessary to control a method of detecting vehicles by taking into consideration the surrounding environment or the system operating environment because a road environment for vehicle detection and the condition of signal processing for vehicle detection may vary.

### SUMMARY OF THE INVENTION

Accordingly, the present invention has been made keeping in mind the above problems occurring in the prior art, and an object of the present invention is to provide an apparatus and method for detecting vehicles, which are capable of processing signals by taking into consideration a road environment or the surrounding conditions when detecting a vehicle using a magnetic sensor.

In order to accomplish the above object, the present invention provides a vehicle detection method of detecting vehicles using an apparatus, the method including generating a magnetic signal indicating a magnetic field versus time; generating a waveform based on a level value of the magnetic field of the magnetic signal per unit time, the level value generated using the magnetic signal; correcting the waveform based on previously stored magnetic signal summary information; and detecting a vehicle by applying a predetermined vehicle detection algorithm to the corrected waveform.

In accordance with another aspect of the present invention, there is provided a vehicle detection method of detecting a vehicle and transferring a result of the detection to a base station, the method including generating a magnetic signal indicating a magnetic field versus time; generating waveform information, including a level value of the magnetic field of the magnetic signal per unit time, using the magnetic signal; when ON information indicating that a new vehicle has been detected is detected from the waveform information, transferring vehicle detection information, including the ON information, to the base station; and when OFF information indicating that a detected vehicle has not been detected because the vehicle has moved is detected from the waveform information, transferring vehicle detection information, including the OFF information, to the base station.

In accordance with another aspect of the present invention, there is provided an apparatus for detecting vehicles, the apparatus including a signal generation unit for generating a magnetic signal indicating a magnetic field versus time using a magnetic sensor; and a vehicle detection unit for generating magnetic signal waveform information, including a level value of the magnetic field of the magnetic signal per unit time, using a predetermined time summary unit and a magnetic signal summary unit, and extracting vehicle detection information, indicating whether a vehicle is present, from the magnetic signal waveform information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a system for detecting vehicles according to an embodiment of the present invention;

FIG. 2 is a diagram showing a magnetic signal measured by a magnetic sensor node according to an embodiment of the present invention;

FIG. 3 is a diagram showing a method whereby a magnetic sensor node transfers vehicle detection information according to an embodiment of the present invention;

FIG. 4 is a diagram showing a method whereby a relay node transfers vehicle detection information according to an embodiment of the present invention;

FIG. 5 is a diagram showing a method whereby a base station transfers vehicle detection information according to an embodiment of the present invention;

FIG. 6 is a diagram showing the construction of the magnetic sensor node according to an embodiment of the present invention;

FIG. 7 is a diagram showing a method of generating magnetic signal summary information according to an embodiment of the present invention;

FIG. 8 is a diagram showing a vehicle detection signal according to an embodiment of the present invention;

FIG. 9 is a diagram showing the average value of a magnetic field per unit time according to an embodiment of the present invention;

FIG. 10 is a diagram showing the level value of the magnetic field per unit time according to an embodiment of the present invention;

FIG. 11 is a diagram showing a vehicle detection waveform according to an embodiment of the present invention;

FIG. 12 is a diagram showing a magnetic signal summary table according to an embodiment of the present invention;

FIG. 13 is a diagram showing a method of detecting vehicles according to an embodiment of the present invention;

FIG. 14 is a diagram showing a method of generating waveform information according to an embodiment of the present invention;

FIG. 15 is a diagram showing a waveform of an estimated magnetic signal according to an embodiment of the present invention;

FIG. 16 is a diagram showing a method whereby a magnetic sensor node updates magnetic signal summary related information according to an embodiment of the present invention;

FIG. 17 is a diagram showing a method whereby a relay node transfers parameter information according to an embodiment of the present invention; and

FIG. 18 is a diagram showing a method whereby a base station transfers parameter information according to an embodiment of the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

A system and method for detecting vehicles according to embodiments of the present invention will be described below with reference to the accompanying drawings.

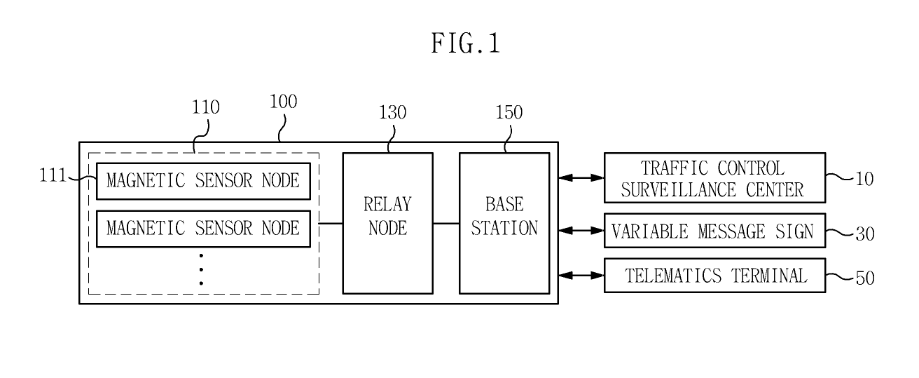

First, referring to FIG. 1, the construction of the system for detecting vehicles according to an embodiment of the present invention will now be described.

FIG. 1 is a diagram showing the construction of the system for detecting vehicles according to an embodiment of the present invention.

As shown in FIG. 1, the system for detecting vehicles 100 includes a magnetic sensor network 110, a relay node 130, and a base station 150.

The magnetic sensor network 110 includes magnetic sensor nodes 111 which are installed along roads, and generates vehicle detection information by measuring changes in the magnetic field when a vehicle moves

The relay node 130 collects the vehicle detection information from the magnetic sensor network 110, and transfers it to the base station 150.

The base station 150 receives the vehicle detection information from the relay node 130, analyzes the speed of the vehicle and the traffic of the road using the received vehicle detection information, and transfers the results of the analysis to a traffic control surveillance center 10, a variable message sign 30, or a telematics terminal 50.

Here, the traffic control surveillance center 10 collects road information or traffic information, controls traffic signals, and provides information, such as traffic conditions, traffic regulations, and traffic accidents, via traffic status message signs or traffic broadcasting.

Furthermore, the variable message sign 30 is installed in a location near the road, and displays traffic information received via wired and wireless communication.

Furthermore, the telematics terminal 50 is installed in a vehicle, and displays traffic information received via wireless communication.

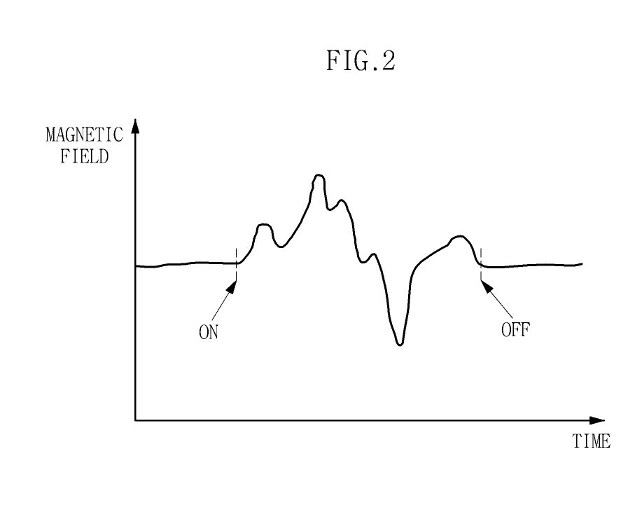

A method of the magnetic sensor node generating vehicle detection information using a magnetic signal according to an embodiment of the present invention will now be described with reference to FIG. 2.

FIG. 2 is a diagram showing a magnetic signal measured by the magnetic sensor node according to an embodiment of the present invention.

As shown in FIG. 2, each of the magnetic sensor nodes 111 generates vehicle detection information, including vehicle presence information, information about the time when the vehicle presence information was detected, and additional information, from a magnetic signal indicating a magnetic field versus time.

Here, the vehicle presence information may include ON information indicating that a new vehicle has been detected or OFF information indicating that a vehicle has not been detected because the vehicle has moved.

If a change in the magnetic field in the magnetic signal is equal to or greater than a critical value, the magnetic sensor node 111 may detect ON information or OFF information.

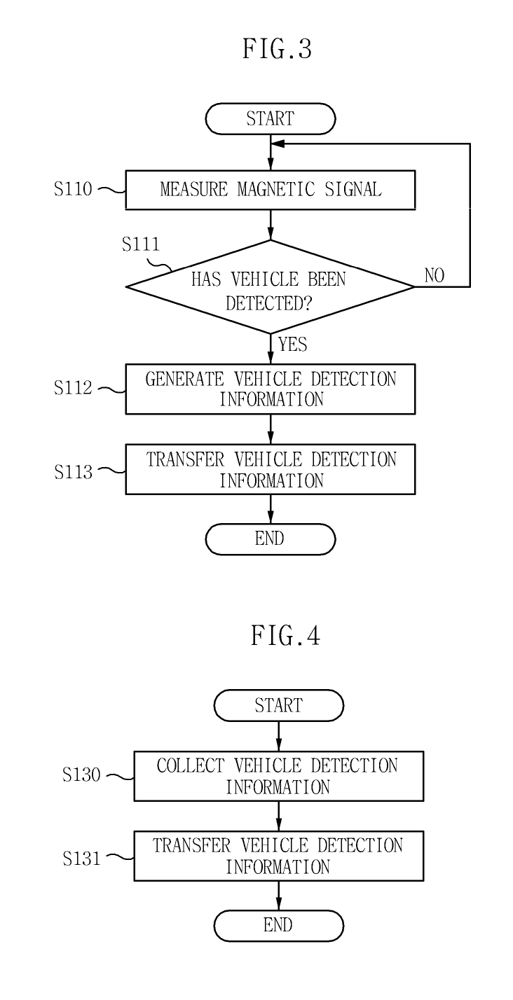

Referring to FIGS. 3 to 5, a method of transferring vehicle detection information in the system for detecting vehicles according to an embodiment of the present invention will now be described.

FIG. 3 is a diagram showing a method whereby the magnetic sensor node transfers vehicle detection information according to an embodiment of the present invention.

As shown in FIG. 3, first, the magnetic sensor node 111 measures a magnetic signal in order to detect a vehicle which approaches the magnetic sensor node 111 at step S110.

The magnetic sensor node 111 determines whether a vehicle has been detected by applying a vehicle detection algorithm to the detected magnetic signal at step S111.

The vehicle detection algorithm may be one of a large variety of conventional algorithms. For example, Korean Patent Application Publication Number 2010-0062844 discloses an algorithm for detecting vehicle using magnetic signal.

If a vehicle has been detected, the magnetic sensor node 111 generates vehicle detection information at step S112.

Thereafter, the magnetic sensor node 111 transfers the generated vehicle detection information to the relay node 130 at step S113.

FIG. 4 is a diagram showing a method whereby the relay node 130 transfers vehicle detection information according to an embodiment of the present invention.

As shown in FIG. 4, first, the relay node 130 collects the vehicle detection information from the magnetic sensor network 110 at step S130. Here, the relay node 130 may perform additional processing on the collected vehicle detection information.

The relay node 130 transfers the collected vehicle detection information to the base station 150 at step S131.

FIG. 5 is a diagram showing a method of the base station 150 transferring vehicle detection information according to an embodiment of the present invention.

As shown in FIG. 5, first, the base station 150 receives the vehicle detection information from the relay node 130 at step S150.

The base station 150 calculates the speed of the vehicle, the traffic on a road, and the occupation ratio by analyzing the received vehicle detection information at step S151.

The base station 150 transfers the results of the analysis to the traffic control surveillance center 10, the variable message sign 30, and the telematics terminal 50 at step S152.

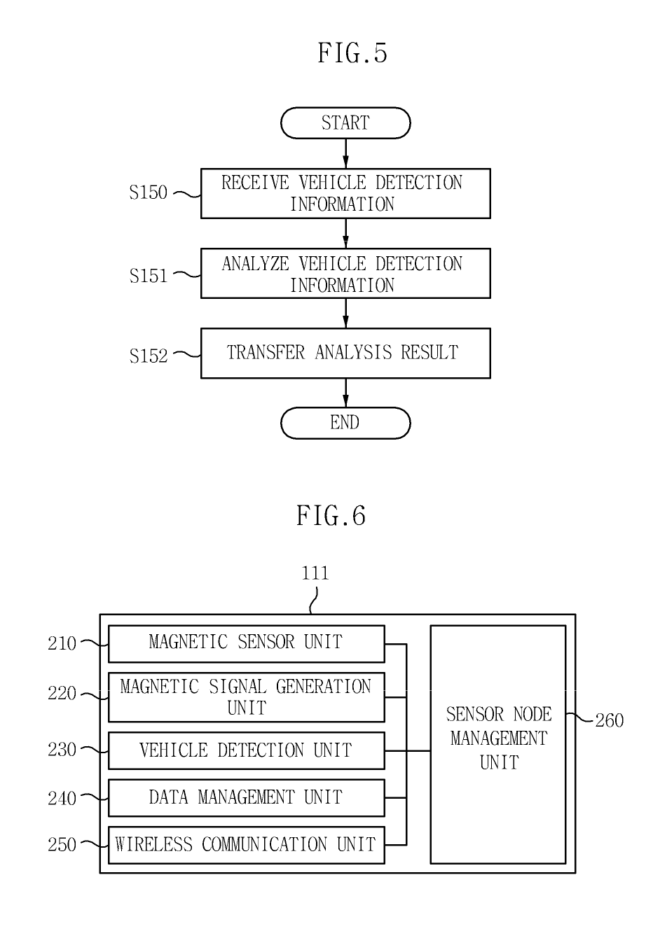

Referring to FIG. 6, the construction of the magnetic sensor node according to the embodiment of the present invention will now be described. Here, the magnetic sensor node according to the embodiment of the present invention corresponds to a vehicle detection device.

FIG. 6 is a diagram showing the construction of each of the magnetic sensor nodes 111 according to the embodiment of the present invention.

As shown in FIG. 6, each of the magnetic sensor nodes 111 includes a magnetic sensor unit 210, a magnetic signal generation unit 220, a vehicle detection unit 230, a data management unit 240, a wireless communication unit 250, and a sensor node management unit 260.

The magnetic sensor unit 210 measures a magnetic field.

The magnetic signal generation unit 220 generates a magnetic signal indicating the magnetic field versus time using the magnetic sensor unit 210.

The vehicle detection unit 230 detects whether a vehicle is present by applying the vehicle detection algorithm to the magnetic signal. Here, the vehicle detection unit 230 may detect whether a vehicle is present using the data management unit 240.

The data management unit 240 stores and manages data and information necessary for vehicle detection. Here, the data management unit 240 includes the latest magnetic signal information, magnetic signal summary information, magnetic signal summary related information, and vehicle detection status information. The latest magnetic signal information indicates N recent magnetic signals and a processing result value for the N recent magnetic signals. The processing result value may indicate the average of the M most recent magnetic signal values. Furthermore, the magnetic signal summary information indicates information about a magnetic signal when the presence of a vehicle has been determined, and the magnetic signal summary related information indicates a parameter for generating, interpreting, or analyzing the magnetic signal summary information. Furthermore, the vehicle detection status information indicates the execution state of the vehicle detection algorithm, such as state transition information that must be referred to in order to execute the vehicle detection algorithm.

The wireless communication unit 250 communicates with the relay node 130 via a wireless connection.

The sensor node management unit 260 manages the operations and states of the magnetic sensor unit 210, the magnetic signal generation unit 220, the vehicle detection unit 230, the data management unit 240, and the wireless communication unit 250.

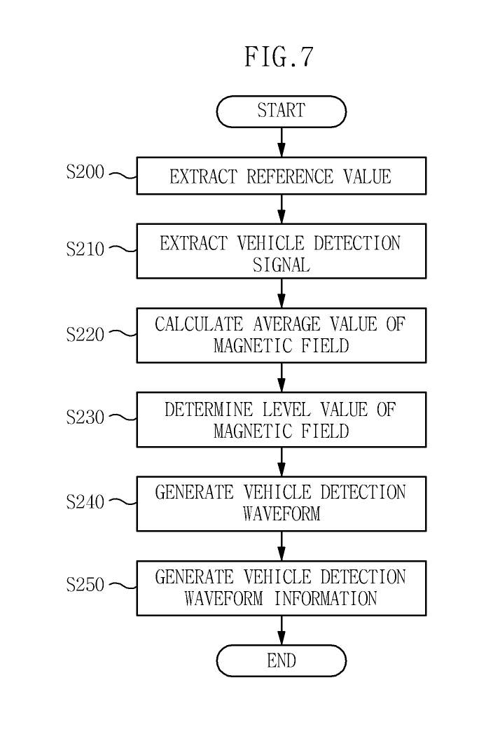

Referring to FIG. 7, a method whereby the magnetic sensor node generates magnetic signal summary information according to an embodiment of the present invention will now be described.

FIG. 7 is a diagram showing the method of generating the magnetic signal summary information according to the embodiment of the present invention.

As shown in FIG. 7, first, the vehicle detection unit 230 of the magnetic sensor node 111 extracts a reference value, indicative of the average value of a magnetic field when a vehicle is not present, from a magnetic signal detected when the vehicle is present at step S200.

Thereafter, the vehicle detection unit 230 of the magnetic sensor node 111 extracts a vehicle detection signal, corresponding to a signal for a section where the vehicle is present, from the magnetic signal at step S210. Here, the vehicle detection unit 230 of the magnetic sensor node 111 may detect the vehicle detection signal using an ON signal and an OFF signal which are detected from the magnetic signal.

Thereafter, the vehicle detection unit 230 of the magnetic sensor node 111 calculates the average value of the magnetic field of the vehicle detection signal per unit time based on a predetermined time summary unit at step S220. Here, the unit time corresponds to the time summary unit for the vehicle detection signal, and the time summary unit may be included in the magnetic signal summary related information stored in the data management unit 240.

Thereafter, the vehicle detection unit 230 of the magnetic sensor node 111 determines the level value of the magnetic field of the vehicle detection signal per unit time based on the average value of the magnetic field of the vehicle detection signal per unit time using the predetermined magnetic signal summary unit at step S230. Here, the magnetic signal summary unit may be included in the magnetic signal summary related information stored in the data management unit 240.

Thereafter, the vehicle detection unit 230 of the magnetic sensor node 111 generates a vehicle detection waveform using the reference value and the level value of the magnetic field per unit time at step S240.

Thereafter, the vehicle detection unit 230 of the magnetic sensor node 111 generates vehicle detection waveform information using the vehicle detection waveform at step S250. Here, the vehicle detection waveform information may include a summary information ID, the summary information length, summary information, a similarity frequency, and attribute information.

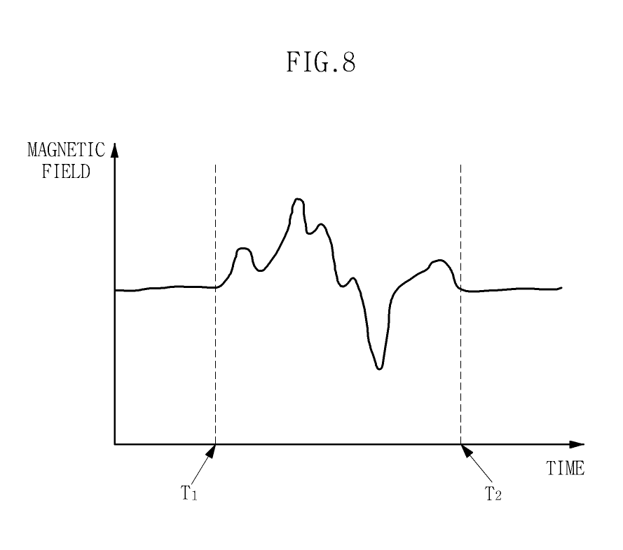

Referring to FIG. 8, a method whereby the magnetic sensor node extracts the vehicle detection signal according to an embodiment of the present invention will now be described.

FIG. 8 is a diagram showing a vehicle detection signal according to an embodiment of the present invention.

As shown in FIG. 8, the vehicle detection unit 230 of the magnetic sensor node 111 may detect a signal for a section between a point of time t₁ at which ON information was detected and a point of time t₂ at which OFF information was detected as the vehicle detection signal from the magnetic signal.

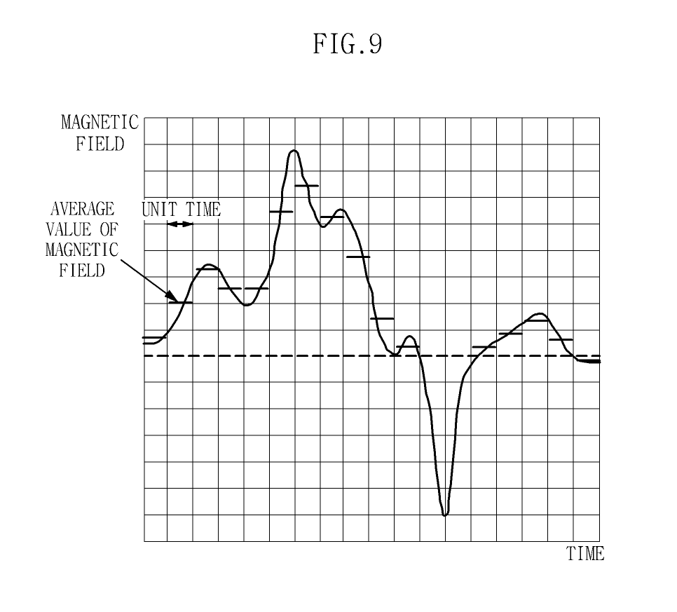

Referring to FIG. 9, a method whereby the magnetic sensor node calculates the average value of the magnetic field per unit time for the vehicle detection signal according to an embodiment of the present invention will now be described.

FIG. 9 is a diagram showing the average value of the magnetic field per unit time according to the embodiment of the present invention.

As shown in FIG. 9, the vehicle detection unit 230 of the magnetic sensor node 111 may calculate the average value of the magnetic field of the vehicle detection signal per unit time.

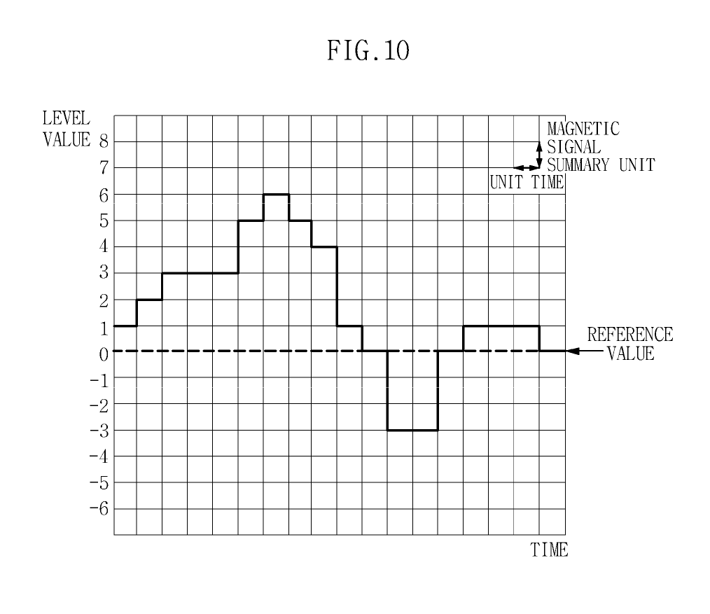

Referring to FIG. 10, a method whereby the magnetic sensor node determines the level of the magnetic field of the vehicle detection signal per unit time according to an embodiment of the present invention will now be described.

FIG. 10 is a diagram showing the level value of the magnetic field per unit time according to an embodiment of the present invention.

As shown in FIG. 10, the vehicle detection unit 230 of the magnetic sensor node 111 may generate an intermediate signal, including the level value of the magnetic field per unit time, by determining a level value corresponding to the average value of the magnetic field of the vehicle detection signal per unit time. Here, the magnetic sensor node 111 may determine the level value of the magnetic field according to a predetermined magnetic signal summary unit based on a reference value indicative of the average value of a magnetic field when a vehicle is not present.

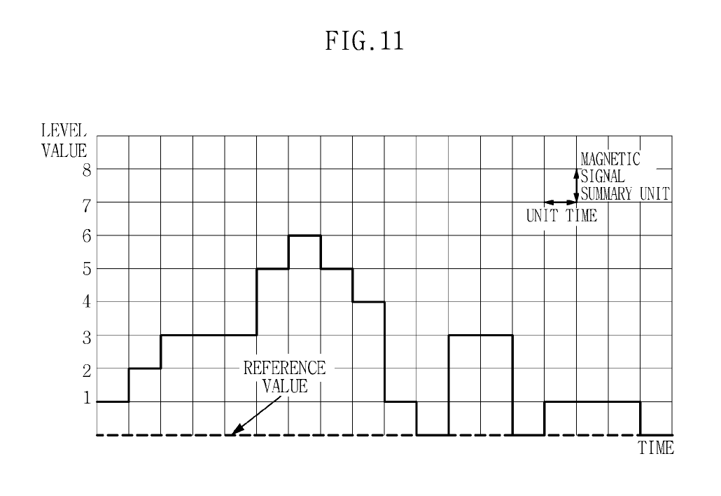

Referring to FIG. 11, a method whereby the magnetic sensor node generates the vehicle detection waveform according to an embodiment of the present invention will now be described.

FIG. 11 is a diagram showing the vehicle detection waveform according to the embodiment of the present invention.

As shown in FIG. 11, the vehicle detection unit 230 of the magnetic sensor node 111 may generate the vehicle detection waveform by making signals symmetrical to each other around the reference value for the intermediate signal including the level value of the magnetic field per unit time.

The reason why the vehicle detection waveform is generated by making signals symmetrical to each other as described above is that in the case where there is a change in the magnetic field generated when a vehicle moves, the width of a changing magnetic field for a given reference value is more important than the height of the magnetic field for the given reference value and the change in the magnetic field attributable to the movement of the vehicle is maintained even when the signals are made symmetrical to each other.

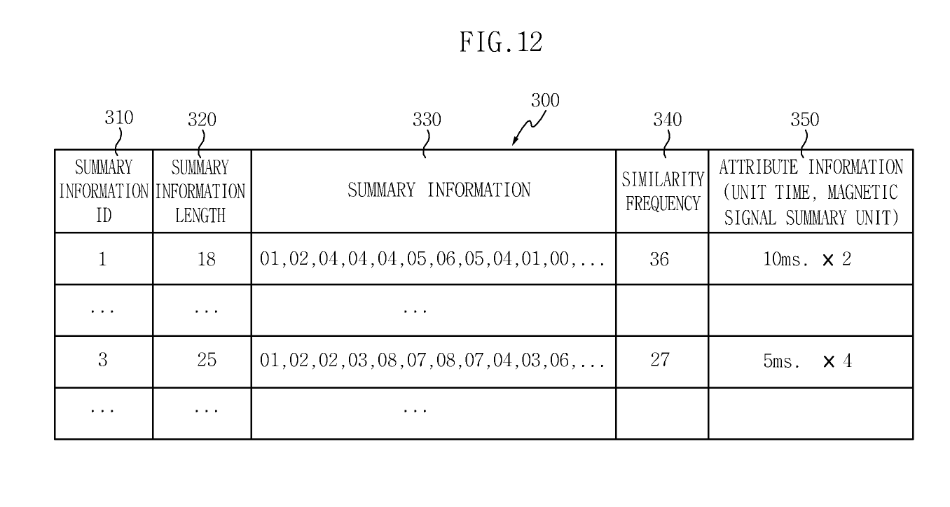

Referring to FIG. 12, a magnetic signal summary table corresponding to the magnetic signal summary information according to an embodiment of the present invention will now be described.

FIG. 12 is a diagram showing the magnetic signal summary table according to the embodiment of the present invention.

As shown in FIG. 12, the data management unit 240 of the magnetic sensor node 111 may store vehicle detection waveform information, corresponding to a vehicle detection waveform, in the magnetic signal summary table 300. Here, the magnetic signal summary table 300 includes a summary information ID 310, a summary information length 320, summary information 330, a similarity frequency 340, and attribute information 350.

The summary information ID 310 indicates an ID value of the vehicle detection waveform information.

The summary information length 320 indicates the length of the vehicle detection waveform.

The summary information 330 indicates a level value of the magnetic field of the vehicle detection waveform per unit time.

The similarity frequency 340 indicates the number of times that relevant vehicle detection waveform information is generated.

The attribute information 350 indicates a unit time and a magnetic signal summary unit for the vehicle detection waveform.

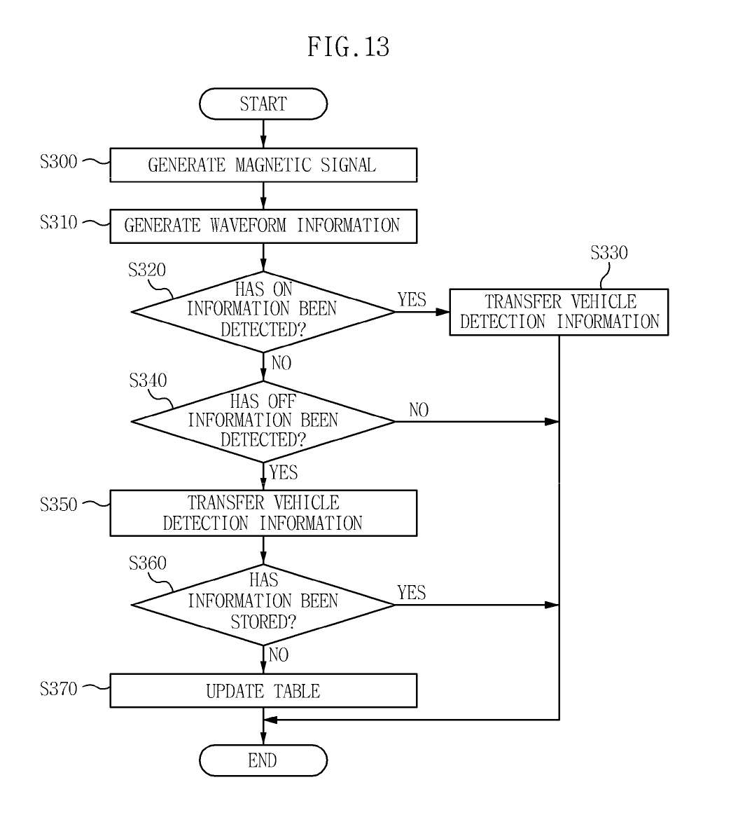

Referring to FIG. 13, a method whereby the magnetic sensor node detects a vehicle from a magnetic signal according to an embodiment of the present invention will now be described.

FIG. 13 is a diagram showing the method of detecting vehicles according to the embodiment of the present invention.

As shown in FIG. 13, first, the magnetic signal generation unit 220 of the magnetic sensor node 111 generates a magnetic signal for a predetermined time in each cycle at step S300.

Thereafter, the vehicle detection unit 230 of the magnetic sensor node 111 generates the waveform information of the magnetic signal at step S310.

The vehicle detection unit 230 of the magnetic sensor node 111 determines whether ON information indicating that a new vehicle has been detected has been detected by analyzing the waveform information of the magnetic signal at step S320.

If, as a result of the determination at step S320, it is determined that the ON information has been detected, the vehicle detection unit 230 of the magnetic sensor node 111 transfers vehicle detection information, providing notification that the new vehicle has been detected, to the relay node 130 via the wireless communication unit 250 at step S330.

If, as a result of the determination at step S320, it is determined that the ON information has been detected, the vehicle detection unit 230 of the magnetic sensor node 111 determines whether OFF information, indicating that a vehicle has not been detected because a detected vehicle has moved, has been detected at step S340.

If, as a result of the determination at step S340, it is determined that the OFF information has been detected, the vehicle detection unit 230 of the magnetic sensor node 111 transfers vehicle detection information, providing notification that a vehicle has not been detected because a detected vehicle has moved, to the relay node 130 via the wireless communication unit 250 at step S350.

Thereafter, the data management unit 240 of the magnetic sensor node 111 determines whether information corresponding to the waveform information of the magnetic signal has been stored in the magnetic signal summary table by searching the magnetic signal summary table at step S360.

If, as a result of the determination at step S360, it is determined that the information has not been stored in the magnetic signal summary table, the data management unit 240 of the magnetic sensor node 111 updates the magnetic signal summary table by storing the waveform information of the magnetic signal in the magnetic signal summary table at step S370.

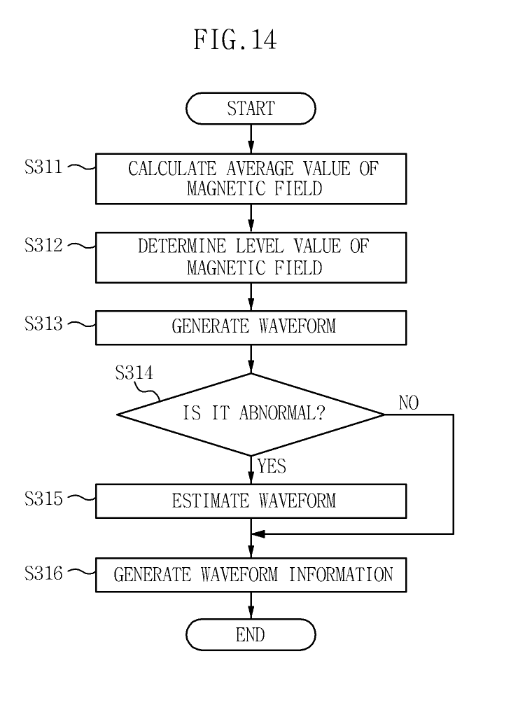

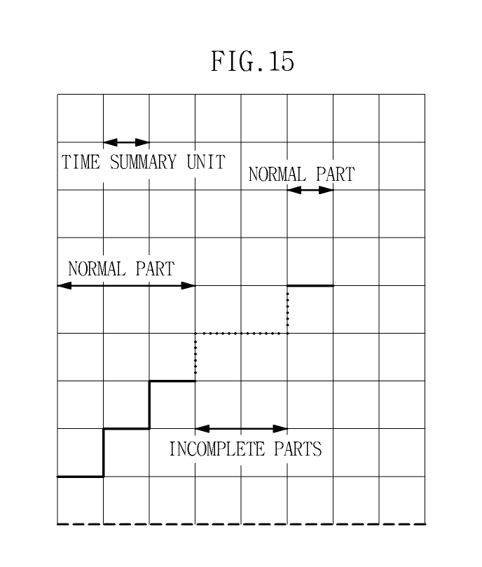

Referring to FIGS. 14 and 15, a method whereby the magnetic sensor node generates the waveform information of the magnetic signal according to an embodiment of the present invention will now be described.

FIG. 14 is a diagram showing a method whereby waveform information is generated according to an embodiment of the present invention.

As shown in FIG. 14, first, the vehicle detection unit 230 of the magnetic sensor node 111 calculates the average value of the magnetic field of a magnetic signal per unit time according to a predetermined time summary unit at step S311. Here, the unit time corresponds to a time summary unit.

Thereafter, the vehicle detection unit 230 of the magnetic sensor node 111 determines a level value of the magnetic field of the magnetic signal per unit time from the average value of the magnetic field of the magnetic signal per unit time using the predetermined magnetic signal summary unit at step S312. Here, the vehicle detection unit 230 of the magnetic sensor node 111 may determine the level value of the magnetic field of the magnetic signal per unit time using the magnetic signal summary unit and a reference value indicative of the average value of a magnetic field when a vehicle is not detected.

Thereafter, the vehicle detection unit 230 of the magnetic sensor node 111 generates a waveform of the magnetic signal using the reference value and the level value of the magnetic field per unit time at step S313.

Thereafter, the vehicle detection unit 230 of the magnetic sensor node 111 determines whether the waveform of the magnetic signal is abnormal at step S314.

If, as a result of the determination at step S314, it is determined that the waveform of the magnetic signal is abnormal, the vehicle detection unit 230 of the magnetic sensor node 111 estimates the waveform of the magnetic signal based on previously stored magnetic signal summary information at step S315.

Thereafter, the vehicle detection unit 230 of the magnetic sensor node 111 generates the waveform information of the magnetic signal using the estimated waveform of the magnetic signal at step S316. Here, if, as a result of the determination at step S314, it is determined that the waveform of the magnetic signal is abnormal, the vehicle detection unit 230 of the magnetic sensor node 111 may generate the waveform information of the magnetic signal using the waveform of the magnetic signal.

FIG. 15 is a diagram showing the waveform of the estimated magnetic signal according to an embodiment of the present invention.

As shown in FIG. 15, the magnetic sensor node 111 may estimate incomplete parts in the waveform of the magnetic signal based on previously stored magnetic signal summary information. The magnetic sensor node 111 may estimate the waveform of the magnetic signal based on the correlation and difference between normal parts and the magnetic signal summary information in the waveform of the magnetic signal.

For example, the magnetic sensor node 111 may estimate the waveform of incomplete parts (i.e., fourth and fifth time summary units) in the waveform of the magnetic signal.

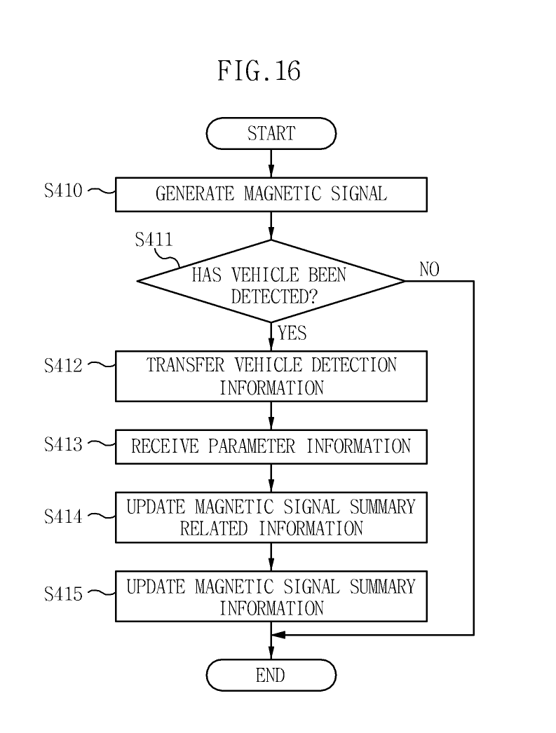

Referring to FIGS. 16 to 18, a method whereby magnetic signal summary related information is updated according to an embodiment of the present invention will now be described.

FIG. 16 is a diagram showing the method whereby the magnetic sensor node updates magnetic signal summary related information according to an embodiment of the present invention.

As shown in FIG. 16, first, the magnetic sensor node 111 generates a magnetic signal at step S410.

The magnetic sensor node 111 determines whether a vehicle has been detected based on the magnetic signal by applying a vehicle detection algorithm to the magnetic signal at step S411.

If, as a result of the determination at step S411, it is determined that a vehicle has been detected based on the magnetic signal, the magnetic sensor node 111 transfers vehicle detection information to the relay node 130 at step S412.

Thereafter, the magnetic sensor node 111 receives parameter information from the relay node 130 at step S413.

The magnetic sensor node 111 updates stored magnetic signal summary related information based on the received parameter information at step S414.

The magnetic sensor node 111 updates magnetic signal summary information based on the updated magnetic signal summary related information at step S415.

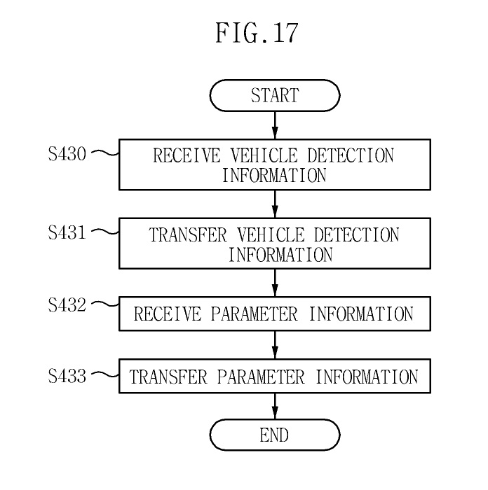

FIG. 17 is a diagram showing a method whereby a relay node transfers parameter information according to an embodiment of the present invention.

As shown in FIG. 17, first, the relay node 130 receives vehicle detection information from the magnetic sensor node 111 at step S430.

The relay node 130 transfers the received vehicle detection information to the base station 150 at step S431.

Thereafter, the relay node 130 receives parameter information from the base station 150 at step S432.

The relay node 130 transfers the received parameter information to the magnetic sensor node 111 at step S433.

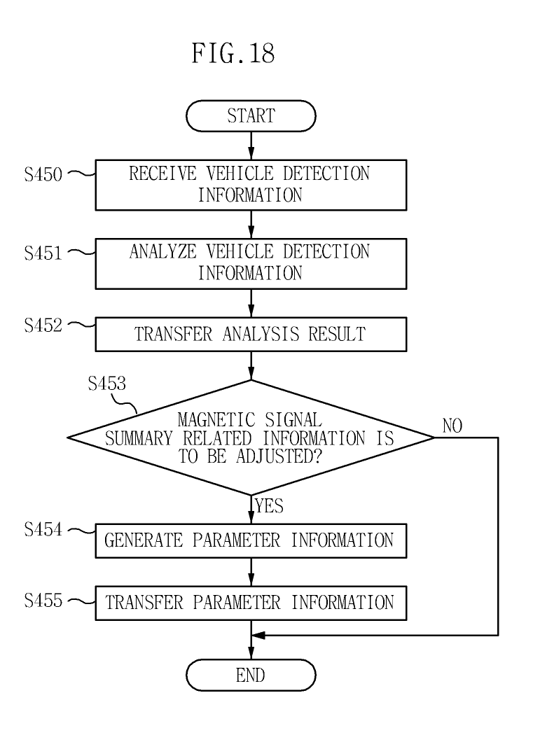

FIG. 18 is a diagram showing a method whereby a base station transfers parameter information according to an embodiment of the present invention.

As shown in FIG. 18, first, the base station 150 receives vehicle detection information from the relay node 130 at step S450.

The base station 150 calculates the speed of a vehicle, the traffic on a road, and the occupation ratio by analyzing the vehicle detection information at step S451.

The base station 150 transfers the analysis result to the traffic control surveillance center 10, the variable message sign 30, and the telematics terminal 50 at step S452.

The base station 150 determines whether to adjust magnetic signal summary related information using the analysis result at step S453. Here, the base station 150 may determine whether to adjust the magnetic signal summary related information by comparing the analysis result with the information received from the traffic control surveillance center 10, the variable message sign 30, and the telematics terminal 50. For example, if the result of vehicle detection is incorrect or magnetic signal summary related information has to be changed because of the road conditions, the base station 150 may adjust the magnetic signal summary related information.

If, as a result of the determination at step S453, the magnetic signal summary related information needs to be adjusted, the base station 150 generates parameter information used for adjusting the magnetic signal summary related information at step S454.

The base station 150 transfers the generated parameter information to the relay node 130 at step S455.

As described above, according to the present invention, an incomplete magnetic signal is corrected using a magnetic signal detected for a vehicle. Accordingly, there is an advantage in that the accuracy and reliability of detecting a vehicle using magnetic sensors that may be influenced by a road environment or a surrounding condition can be improved upon.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle detection method of detecting vehicles using an apparatus, the method comprising:
generating a magnetic signal indicating a magnetic field versus time;
generating a waveform based on a level value of the magnetic field of the magnetic signal per unit time, the level value generated using the magnetic signal;
correcting the waveform based on previously stored magnetic signal summary information; and
detecting a vehicle by applying a predetermined vehicle detection algorithm to the corrected waveform.

2. The vehicle detection method as set forth in claim 1, wherein the generating a waveform comprises:
calculating an average value of the magnetic field of the magnetic signal per unit time based on a predetermined time summary unit; and
determining the level value of the magnetic field of the magnetic signal per unit time from the average value of the magnetic field of the magnetic signal per unit time using a predetermined magnetic signal summary unit.

3. The vehicle detection method as set forth in claim 2, wherein the determining the level value of the magnetic field of the magnetic signal per unit time comprises determining the level value of the magnetic field of the magnetic signal per unit time further using a magnetic field when a vehicle is not detected.

4. The vehicle detection method as set forth in claim 1, further comprising, before the generating the magnetic signal, generating the magnetic signal summary information using a vehicle detection signal generated when a vehicle is detected.

5. The vehicle detection method as set forth in claim 4, wherein the generating the magnetic signal summary information comprises:
calculating the average value of the magnetic field of the vehicle detection signal per unit time based on a predetermined time summary unit;
determining the level value of the magnetic field of the vehicle detection signal per unit time from the average value of the magnetic field of the vehicle detection signal per unit time using a predetermined magnetic signal summary unit; and
generating the magnetic signal summary information including the level value of the magnetic field of the vehicle detection signal per unit time.

6. The vehicle detection method as set forth in claim 4, wherein the vehicle detection signal is a signal for a section between a point of time at which a vehicle is newly detected and a point of time at which a vehicle is not detected because the newly detected vehicle has moved.

7. A vehicle detection method of detecting a vehicle and transferring a result of the detection to a base station, the method comprising:
generating a magnetic signal indicating a magnetic field versus time;
generating waveform information, including a level value of the magnetic field of the magnetic signal per unit time, using the magnetic signal;
when ON information indicating that a new vehicle has been detected is detected from the waveform information, transferring vehicle detection information, including the ON information, to the base station; and
when OFF information indicating that a detected vehicle has not been detected because the vehicle has moved is detected from the waveform information, transferring vehicle detection information, including the OFF information, to the base station.

8. The method of detecting vehicles as set forth in claim 7, wherein the transferring vehicle detection information, including the OFF information, to the base station comprises determining whether the OFF information has been detected from the waveform information if the ON information is not detected from the waveform information.

9. The method of detecting vehicles as set forth in claim 7, further comprising storing the level value of the magnetic field of the magnetic signal per unit time in a magnetic signal summary table.

10. An apparatus for detecting vehicles, the apparatus comprising:
a signal generation unit for generating a magnetic signal indicating a magnetic field versus time using a magnetic sensor; and
a vehicle detection unit for generating magnetic signal waveform information, including a level value of the magnetic field of the magnetic signal per unit time, using a predetermined time summary unit and a magnetic signal summary unit, and extracting vehicle detection information, indicating whether a vehicle is present, from the magnetic signal waveform information.

11. The vehicle detection apparatus as set forth in claim 10, further comprising a data management unit for storing information about a previously stored vehicle detection signal;
wherein the vehicle detection unit corrects the magnetic signal waveform information based on the information stored in the data management unit and extracts the vehicle detection information from the corrected magnetic signal waveform information.

12. The vehicle detection apparatus as set forth in claim 11, wherein the vehicle detection unit generates vehicle detection waveform information, including the level value of the magnetic field of the vehicle detection signal per unit time, using the time summary unit and the magnetic signal summary unit, and stores the vehicle detection waveform information in the data management unit.

13. The vehicle detection apparatus as set forth in claim 12, wherein the vehicle detection unit calculates the average value of the magnetic field of the vehicle detection signal per unit time based on the time summary unit, and determines the level value of the magnetic field of the magnetic signal per unit time from the average value of the magnetic field of magnetic signal per unit time using the magnetic signal summary unit.

14. The vehicle detection apparatus as set forth in claim 13, wherein the vehicle detection unit determines the level value of the magnetic field of the magnetic signal per unit time further using the average value of a magnetic field when the vehicle is not present.

15. The vehicle detection apparatus as set forth in claim 10, wherein the vehicle detection unit extracts the vehicle detection information including information providing notification that a vehicle has been newly detected and information providing notification that the detected vehicle has not been detected.
